(19) United States
(12) Patent Application Publication
(10) Pub. No.: US 2019/0251610 A1
(43) Pub. Date: Aug. 15, 2019

(54) METHOD OF IDENTITY AUTHENTICATION FOR ONLINE STORE

(71) Applicants: Teng-Yao Chang, Taichung City (TW); Peng-Yang Chuang, Taoyuan City (TW)

(72) Inventor: PENG-YANG CHUANG, Taoyuan City (TW)

(73) Assignees: Teng-Yao Chang, Taichung City (TW); Peng-Yang Chuang, Taoyuan City (TW)

(21) Appl. No.: 15/993,834

(22) Filed: May 31, 2018

(30) Foreign Application Priority Data
Feb. 14, 2018 (TW) 107105562

(51) Int. Cl. G06Q 30/06; H04L 29/06

(52) U.S. Cl. CPC G06Q 30/0609; G06F 8/60; H04L 63/0884; H04L 63/0853

(57) ABSTRACT

A method of identity authentication for an online store includes steps of transmitting a device code of a first electronic device to a first server, and waiting to receive an authentication code sending back from the first server; establishing a web page corresponding to the authentication code on a second server via the first electronic device; generating a link information corresponding to the web page by the first electronic device; obtaining the link information by the second electronic device, and connecting the second electronic device to the web page according to the link information whereby, it can effectively verify the authenticity of the first electronic device so as to bind the web page to the first electronic device, which can improve the transaction security.

### BACKGROUND OF THE INVENTION

### 1. Technical Field

The present invention relates to online transactions, and more particularly to an identity authentication method for an online store.

### 2. Description of Related Art

With the advancement in communication technology, the internet has been developed far and wide. While in the past, wired desktop computers could be used to connect to the Internet, now portable mobile electronic devices are commonly used as terminal devices for connecting to the internet. As a result of the convenience and widespread use of such electronic devices, the booming of the internet has completely changed people's lifestyles and is more closely involved with people's daily activities. Many consumers have also changed from shopping at traditional physical stores to online stores.

Online shopping is conducted on a virtual platform and incurs no investment in one or more physical stores. Therefore, the barrier to entry and operating threshold of the online store is low, and it is easier for people to enter the online shopping field. For the consumers, the convenience of purchasing products through the internet also forms the main incentive for supporting online shopping.

Although online shopping is convenient, online interactions and transaction are increasingly subject to disputes and fraud. Since establishing online stores require minimal investment, consumers risk being defrauded. For example, a “one-page shop” fraud utilizes a platform or a Facebook advertisement to lure the consumers to link to a single web page to shop. However, there may been information about the seller on the web page. Even if there is seller information, the authenticity of the information cannot be verified. Therefore, for consumers online shopping is fraught with risk of fraud. In addition, if such a “one-page store” is built at a server of a store platform, it also results in a problem that the operator of the store platform cannot control the “one-page store”.

### BRIEF SUMMARY OF THE INVENTION

In view of the above, an object of the present invention is to provide an identity authentication method for an online store that can improve transaction security.

The present invention provides a method of identity authentication for an online store, which is applied to a network system including a first server, a second server, a first electronic device, and a second electronic device, wherein the first electronic device includes a device code; the method includes steps of:
A. transmitting the device code of the first electronic device to the first server, and waiting to receive an authentication code sending back from the first server, wherein the authentication code only corresponds to the device code;
B. establishing a web page corresponding to the authentication code on the second server after the first electronic device receiving the authentication code sending from the first server;
C. generating a link information corresponding to the web page by the first electronic device;
D. obtaining the link information by the second electronic device; and
E. connecting the second electronic device to the web page according to the link information.

The advantage of the present invention is that it provides a method which can effectively verify an authenticity of the identity of the first electronic device and form a unique correspondence between the established web page and the first electronic device by binding the authentication code of the first electronic device 10, which can improve the transaction security. In other words, by binding the web page to the first electronic device, repudiation of a transaction may be prevented when a dispute occurs.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a schematic view showing a network system according to a first embodiment of the present invention;

FIG. 2 is a flowchart of an identity authentication method for an online store according to the first embodiment of the present invention;

FIG. 3 is a schematic view showing a network system according to a second embodiment of the present invention; and

FIG. 4 is a flowchart of an identity authentication method for an online store according to the second embodiment of the present invention.

### DETAILED DESCRIPTION OF THE INVENTION

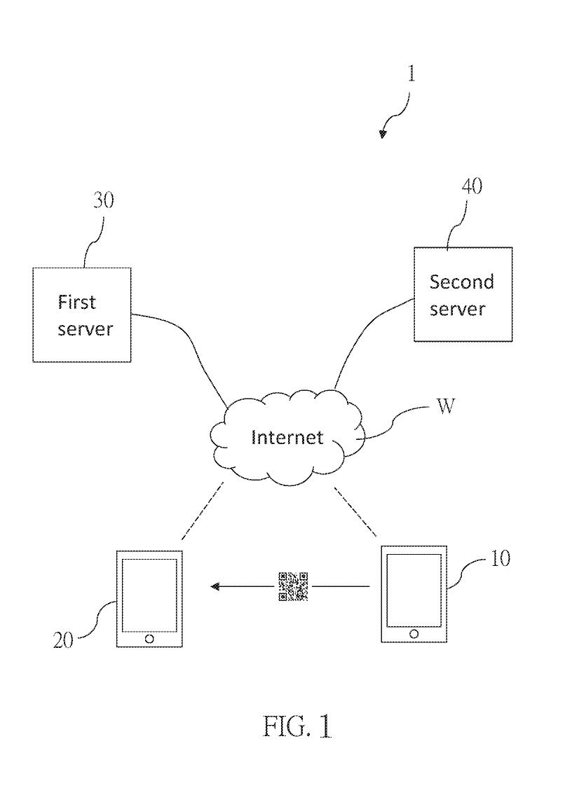

The following illustrative embodiments and drawings are provided to illustrate the disclosure of the present invention, these and other advantages and effects can be clearly understood by persons skilled in the art after reading the disclosure of this specification. According to a first embodiment of the present invention, an identity authentication method for an online store is applied to a network system 1 as an example. As shown in FIG. 1, a network system 1 includes a first electronic device 10, a second electronic device 20, a first server 30, and a second server 40, which are all connected to an internet W.

In the current embodiment, the first electronic device 10 and the second electronic device 20 are mobile electronic devices, i.e., tablet computers, however, this is not a limitation of the present invention. The first electronic device 10 and the second electronic device 20 also could be other types of mobile electronic devices, such as mobile phones, notebooks, wearable devices, etc. In addition, the first electronic device 10 and the second electronic device 20 also could be computers. The first electronic device 10 has a unique device code, which is not overlapped with the device codes of other electronic devices. In the current embodiment, the device code is a hardware serial number of the first electronic device 10, however, this is not a limitation of the present invention. The device code also could be corresponding to a firmware number of the first electronic device 10, or an authentication code of the first electronic device 10. Wherein, the authentication code is obtained from a supplier of an operating system when the first electronic device 10 installs the operating system through an authentication process, and therefore the authentication code will only correspond to the first electronic device 10. The first electronic device 10 is owned by a first user, and the second electronic device 20 is owned by a second user.

The first server 30 is a third-party server and could be a server of an application platform, which is an application store as an example. The first server 30 is set up by the operating system provider of the first electronic device 10.

The second server 40 is a server of an online store which is set up by an operator of the online store. The second server 40 could be adapted to establish a plurality of online stores, each of which has at least one web page for configuring product information to be sold.

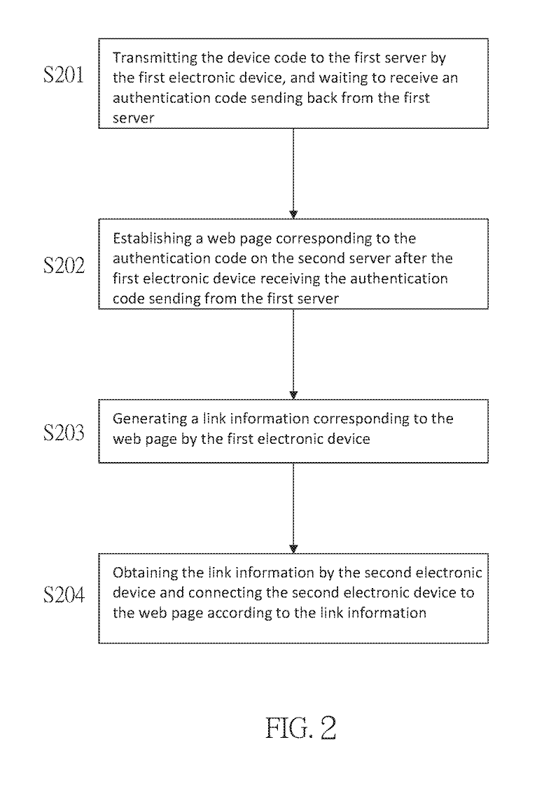

As shown in FIG. 2, the identity authentication method of the first embodiment includes the following steps.

In step S201, the first electronic device 10 transmits the device code to the first server 30 and waits to receive an authentication code sending back from the first server 30. In the current embodiment, the operator of the online store develops and provides an application to the first server 30 to be downloaded for installation. The first electronic device 10 downloads the application from the first server 30 and executes the application. Wherein, the application includes a developer account corresponding to the operator of the online store. After the first electronic device 10 executes the application, the application will obtain the device code of the first electronic device 10. Then, the first electronic device 10 transmits the developer account, the device code, and the account of the first electronic device on the first server 30 to the first server 30. After verifying the developer account, the first server 30 generates a corresponding authentication code according to the device code, and then transmits the authentication code back to the first electronic device 10. The authentication code could be a token and is specifically corresponding to the device code. In other words, a first electronic device 10 will only have a unique authentication code with respect to a developer account.

In step S202, after receiving the authentication code sending back from the first server 30, the first electronic device 10 could establish a web page corresponding to the authentication code on the second server 40. In the current embodiment, the first user could execute the application via the first electronic device 10 to connect to the second server 40. Meanwhile, the first electronic device 10 will transmit the authentication code to the second server 40 to proceed a registration for an identity of the first user so as to create the identity of the first user in the second server 40. For example, the registration requires steps of requesting the first user to input his information, including name, identity card number, receipt account (e.g. bank account or electronic payment account), etc., wherein the receipt account is used for subsequent remittance. The second server 40 records the correspondence between the first user information and the authentication code. After the registration is completed, the first user could create or edit the products to be sold in the second server 40, which becomes a web page. The web page includes at least one product information.

In step S203, the first electronic device 10 generates a link information, which is corresponding to the web page and adapted for directing to the web page, with the application. In the current embodiment, the link information is formed as a QR code. When the QR code is scanned, a link could be directed to the web page. In practice, the link information also could be a textual hyperlinked URL. The link information includes a link address and the authentication code corresponding to the second server.

In step S204, the second electronic device 20 obtains the link information and connects to the corresponding web page according to the link information. In the current embodiment, the second electronic device 20 will analyze the QR code, and then connect to the second server 40 via a web browser or a specified application. During the connection, the second electronic device 20 will transmit the authentication code to the second server 40 at the same time. Thereafter, the second server 40 guides the web browser or the specified application to the web page according to the authentication code.

In this way, the second user can shop on the web page through the second electronic device 20. Then, after the transaction on the web page is completed, the second server 40 can transfer the transaction amount to the receipt account corresponding to the authentication code according to the registered correspondence between the first user information and the authentication code.

In the current embodiment, by utilizing the first server 30, i.e., a third-party server to proceed the authentication of the first electronic device 10, it can assure that the first electronic device 10 will send information via its account on the first server 30. Then, based on the verified authentication code, the web page corresponding to the first electronic device 10 is established at the second server 40. Whereby, it can assure that the online stores only can be set up through the identity authentication steps and that the correspondence between the seller of the products on the web page and the first electronic device. In this way, it can effectively solve the drawbacks that anyone can arbitrarily set up their own online stores in the conventional online transactions, which may result in consumers being cheated.

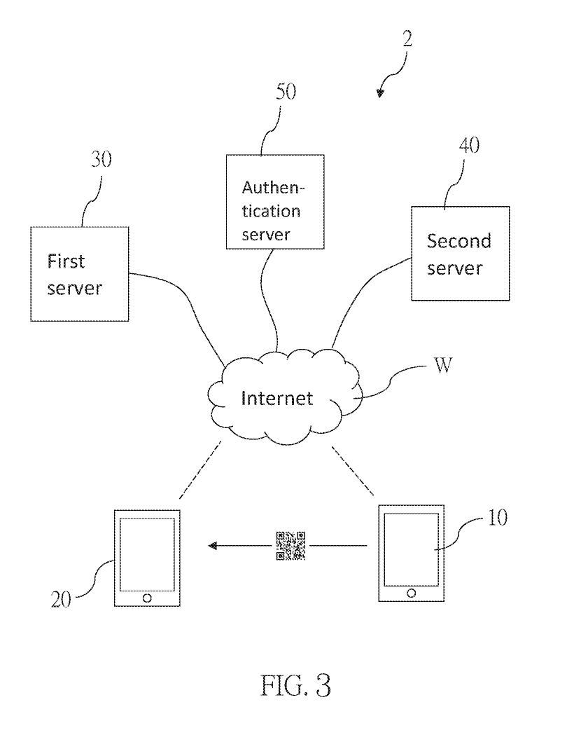

Another embodiment which can further proceed an authentication of the second user will be illustrated below. According to a second embodiment of the present invention, an identity authentication method for an online store is applied to a network system 2 as an example. Referring to FIG. 3, the network system 2 includes a basic configuration as the network system 1 of the first embodiment, and further includes an authentication server 50 connected to the internet W.

The authentication server 50 is adapted to authenticate the identity of the second user. In the current embodiment, the authentication server 50 is referred to a server of a community software, and the community software can be, for example, WeChat, Line, Facebook, etc. Preferably, the community software enables the users to bind their payment accounts.

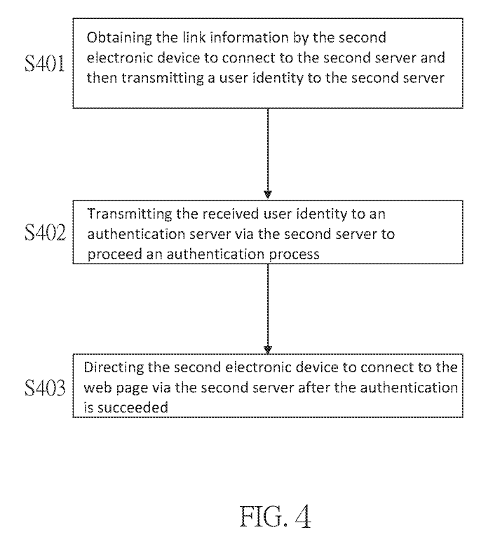

The identity authentication method of the current embodiment includes steps which are substantially the same as those of the first embodiment. The identity authentication method of the current embodiment is different from that of the first embodiment in that, in addition to the foregoing step 204, the step of being linked to the corresponding web page with the link information further includes the steps shown in FIG. 4.

In step S401, the second electronic device 20 obtains the link information and connects to the second server 40, and then transmits a user identity to the second server 40. In the current embodiment, when the second electronic device 20 is connected to the second server 40, the second server 40 will send a request to the second electronic device 20 and ask the second user to input his identity registered in the community software. After the second user inputs his identity into the second electronic device 20, the second electronic device 20 will transmit the user identity to the second server 40.

In step S402, the second server 40 transmits the received user identity to the authentication server 50 to proceed an authentication process. In the current embodiment, when the authentication server 50 verifies that the user identity has a payment account, a successful authentication message will be sent to the second server 40.

In step S403, after the authentication is succeeded, the second server 40 will direct the second electronic device 20 to link to the web page. In the current embodiment, when the second server 40 receives successful authentication message, the second server 40 will determine that the authentication is succeeded and direct the second electronic device 20 to the web page corresponding to the authentication code.

In this way, the second user can use the second electronic device 20 to shop on the web page, and then, after completing the transaction on the web page, the second server 40 can transmit the user identity, which is input by the second user, and the transaction amount to the authentication server 50 such that the transaction amount can be deducted from the payment account of the user identity, and transferred to the receipt account of the first user corresponding to the authentication code.

The method of the current embodiment can provide a protection for the first user by authenticating the identity of the second user of the second electronic device 20. It is worth mentioning that by utilizing the authentication server of the community software to verify that the second user has the payment account, it can assure that the second user can afford to pay after shopping on the web page.

As mentioned above, according to the present invention, the method of identity authentication method for an online store can effectively verify the identity of the first electronic device 10 and form a unique correspondence between the established web page and the first electronic device 10 by binding the authentication code of the first electronic device 10, which ensures the authenticity of the identity of the first electronic device 10. Meanwhile, by binding the web page to the first electronic device 10, it can provide non-repudiation if there is a dispute. In addition, with the authentication process of the identity of the second user, it can also assure the authenticity of the identity of the second user. In this way, the security of online transactions can be effectively improved.

It must be pointed out that the embodiments described above are only some embodiments of the present invention. All equivalent structures which employ the concepts disclosed in this specification and the appended claims should fall within the scope of the present invention.

What is claimed is:

1. A method of identity authentication for an online store, which is applied to a network system including a first server, a second server, a first electronic device, and a second electronic device, wherein the first electronic device includes a device code, the method comprising steps of:
A. transmitting the device code of the first electronic device to the first server, and waiting to receive an authentication code sending back from the first server, wherein the authentication code only corresponds to the device code;
B. establishing a web page corresponding to the authentication code on the second server after the first electronic device receiving the authentication code sending from the first server;
C. generating a link information corresponding to the web page by the first electronic device;
D. obtaining the link information by the second electronic device; and
E. connecting the second electronic device to the web page according to the link information.

2. The method of claim 1, wherein step E of connecting to the web page further comprises the following steps:
connecting the second electronic device to the second server and transmitting a user identity to the second server;
receiving the user identity and then transmitting the user identity to an authentication server to proceed an authentication process via the second server; and
directing the second electronic device to the web page via the second server when the authentication is succeeded.

3. The method of claim 2, wherein the link information includes a link address corresponding to the second server and the authentication code; in step E, the second electronic device connects to the second server according to the link address, and transmits the authentication code to the second server; after the authentication is succeeded, the second electronic device is directed to connect to the web page according to the authentication code.

4. The method of claim 2, wherein the user identity is registered in a community software, and the authentication server corresponds to the community software; when the authentication server verifies that the user identity has a payment account, the authentication server will transmit a successful authentication message to the second server; when the second server receives the successful authentication message, the second server will direct the second electronic device to connect to the web page.

5. The method of claim 1, wherein step A further comprises steps of:
downloading an application from the first server via the first electronic device, wherein the application includes a developer account;
executing the application with the first electronic device and transmitting the developer account and the device code to the first server; and
verifying the developer account and then generating the authentication code according to the device code via the first server.

6. The method of claim 1, wherein the link information is formed as a QR code.

7. The method of claim 1, wherein the device code of the first electronic device is a hardware serial number, a firmware number, or an authentication code, which is corresponding to the first electronic device.

8. The method of claim 1, wherein step B further comprises establishing a correspondence between a first user information and the authentication code on the second server, wherein the user information includes a receipt account; after step E, further comprises transferring a transaction amount to the receipt account corresponding to the authentication code according to the correspondence when the transaction on the web page is completed.
